(19) United States
(12) Patent Application Publication
(10) Pub. No.: US 2017/0275107 A1
(43) Pub. Date: Sep. 28, 2017

(54) TRANSPORT DEVICE

(71) Applicant: FUJI XEROX CO., LTD., Tokyo (JP)

(72) Inventors: Shouichi MAEDA, Kanagawa (JP); Takashi ABE, Kanagawa (JP); Takayuki YAZAWA, Kanagawa (JP); Shinji YAGINUMA, Kanagawa (JP); Junichi ASAOKA, Kanagawa (JP)

(73) Assignee: FUJI XEROX CO., LTD., Tokyo (JP)

(21) Appl. No.: 15/225,922

(22) Filed: Aug. 2, 2016

(30) Foreign Application Priority Data
Mar. 22, 2016 (JP) 2016-056545
Mar. 22, 2016 (JP) 2016-056546

(51) Int. Cl. B65H 1/08; B65H 1/04; G03G 15/00

(52) U.S. Cl. CPC B65H 1/08; G03G 15/6529; B65H 1/04

(57) ABSTRACT

A transport device including: a body unit including a first cover member attached thereto to cover one side portion of an opening formed at one surface of the body unit, an accommodating unit including a second cover member attached thereto to cover the opening, the accommodating unit configured to accommodate a recording medium, the accommodating unit being reciprocally mounted with respect to the opening of the body unit, and a guide member provided on a bottom surface of the accommodating unit, the guide member configured to guide the accommodating unit so that when the accommodating unit is mounted in the body unit, while being fitted to a positioning pin provided in the body unit, the guide member is positioned so that the second cover member has a gap with the first cover member at a position where the accommodating unit is mounted in the body unit.

### CROSS-REFERENCE TO RELATED APPLICATIONS

This application is based on and claims priority under 35 USC 119 from Japanese Patent Application Nos. 2016-056545 filed Mar. 22, 2016 and 2016-056546 filed Mar. 22, 2016.

### BACKGROUND

### Technical Field

The present invention relates to a transport device.

### SUMMARY

According to an aspect of the invention, there is provided a transport device including

a body unit including a first cover member attached thereto to cover one side portion of an opening formed at one surface of the body unit,

an accommodating unit including a second cover member attached thereto to cover the opening, the accommodating unit configured to accommodate a recording medium, the accommodating unit being reciprocally mounted with respect to the opening of the body unit, and

a guide member provided on a bottom surface of the accommodating unit, the guide member configured to guide the accommodating unit so that when the accommodating unit mounted in the body unit, while being fitted to a positioning pin provided in the body unit, the guide member is positioned so that the second cover member has a gap with the first cover member at a position where the accommodating unit is mounted in the body unit.

### BRIEF DESCRIPTION OF THE DRAWINGS

Exemplary embodiments of the present invention will be described in detailed based on the following figures, wherein:

FIG. 1 is a sectional schematic diagram illustrating an internal configuration of an image forming system;

FIG. 2A is a perspective view illustrating the whole of a transport device;

FIG. 2B is a perspective view illustrating a state where an accommodating unit is pulled out;

FIG. 3 is a vertical sectional view of the transport device;

FIG. 4 is a plan view of the transport device in a state where the accommodating unit is slightly pulled out;

FIG. 5 is a bottom view illustrating a guide mechanism of the transport device;

FIG. 6A is a bottom view of the transport device in the state where the accommodating unit is slightly pulled out;

FIG. 6B is a bottom view of the transport device in a process of mounting the accommodating unit;

FIGS. 7A to 7D are bottom schematic diagrams illustrating positioning of the accommodating unit with respect to the body unit; and

FIGS. 8A and 8B are bottom schematic diagrams illustrating positioning of an accommodating unit with respect to a body unit in a transport device of a comparative example.

### DETAILED DESCRIPTION

Hereinafter, the present invention will be described in more detail in connection with exemplary embodiments and specific examples with reference to drawings, but is not limited to the exemplary embodiments and specific examples.

Further, in the following descriptions made with reference to the drawings, it should be noted that the drawings are schematic and the ratios of respective dimensions are different from those of actual ones. For easy understanding, illustrations of members other than those necessary for the descriptions are properly omitted.

In order to facilitate the understanding of the following descriptions, it is assumed that, in the drawings, the front-rear direction is the X-axis direction, the left-right direction is the Y-axis direction, and the up-down direction is the Z-axis direction.

(1) Overall Configuration and Operation of Image Forming System

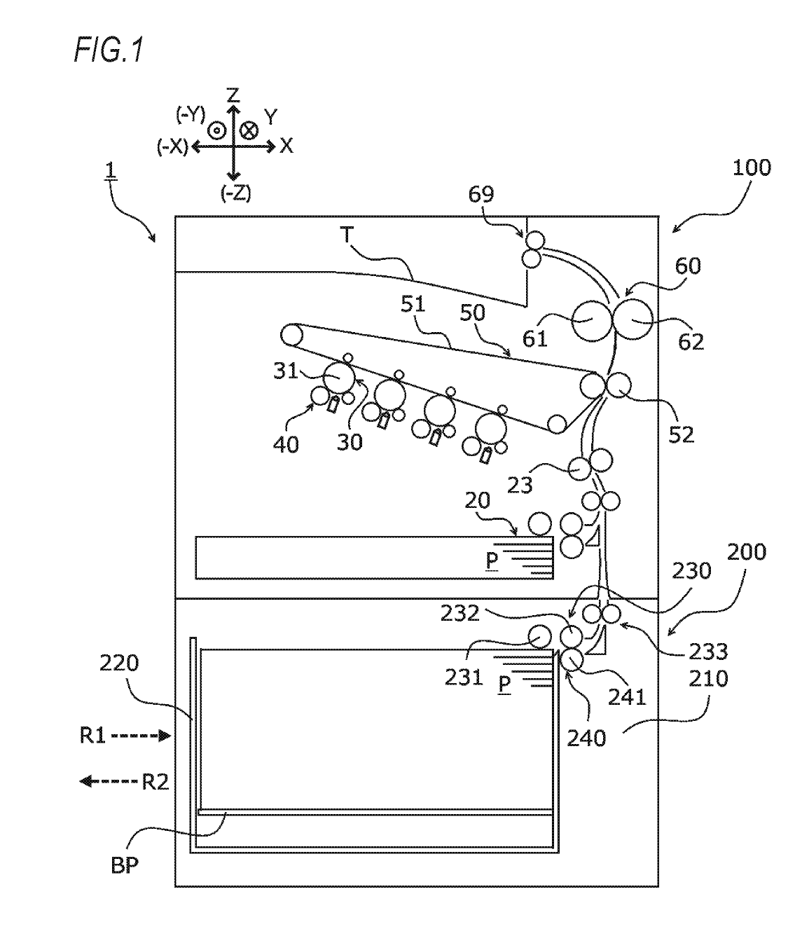

FIG. 1 is a schematic configuration diagram illustrating an image forming system 1 to which a transport device 200 according to the present exemplary embodiment is applied. The image forming system 1 illustrated in FIG. 1 includes an image forming apparatus 100, such as a printer or a copier, which forms an image by an electrophotographic system, and the transport device 200 configured to transport a sheet P as a recording medium on which a toner image is formed, to the image forming apparatus 100.

Hereinafter,the overall configuration and operation of the image forming system 1 will be described with reference to the drawings.

(1.1) Overall Configuration and Operation of Image Forming Apparatus

The image forming apparatus 100 is configured to include a controller 10, a sheet feeding device 20, photoconductor units 30, developing devices 40, a transfer device 50, and a fixing device 60. The transport device 200 is disposed below the image forming apparatus 100 HZ direction), and transports a sheet P, on which an image is to be recorded, to the image forming apparatus 100.

At the bottom portion of the image forming apparatus 100, the sheet feeding device 20 on which sheets P as recording mediums are stacked is provided. Sheets P, of which the position in the width direction is determined on a regulation plate (not illustrated), are pulled out one by one from the top by a sheet pull-out unit 22 forward (-X direction) and transported to a nip portion of a resist roller pair 23.

The photoconductor units 30 include photoconductor drums 31 which are provided, respectively, in parallel above the sheet feeding device 20 (Z direction), and are rotationally driven. On each of the photoconductor drums 31, a toner image of yellow (Y), magenta (K), cyan (C), or black (K) is formed by each of the developing devices 40.

The toner images of respective colors formed, respectively, on the photoconductor drums 31 of the photoconductor units 30 are sequentially electrostatically transferred (primarily transferred) on an intermediate transfer belt 51 of the transfer device 50, and a superimposed toner image obtained by superimposing the toners of respective colors is formed. The superimposed toner image on the intermediate transfer belt 51 is fed from the resist roller pair 23 and collectively transferred to a sheet P guided by a transport guide by a secondary transfer roller 52.

The sheet P on which the toner images are collectively transferred in the transfer device 50 is transported to the fixing device 60 in a state where the toner images are unfixed, and the toner images are fixed through an action of pressing and heating by a pair of heating and pressure modules 61 and

The sheet P formed with the fixed toner images is guided by the transport guide, and discharged to and accommodated in an exit tray unit T formed on the top surface of the image forming apparatus 100 (Z direction) from a pair of exit rollers 69.

(1.2) Overall Configuration and Operation of Transport Device

The transport device 200 includes a body unit 210 and an accommodating unit 220. The body unit 210 is configured to be detachable with respect to the image forming apparatus 100, and has a transport path of a sheet P to be connected to a sheet transport path included in the image forming apparatus 100.

The accommodating unit 220 is configured to accommodate a number of sheets P, and mounted to be reciprocal with respect to the body unit 210. The accommodating unit 220 includes a sheet stacking plate BP on which sheets P are stacked, and moves the sheet stacking plate BP according to the remaining amount of the sheets P.

The accommodating unit 220 is mounted by being moved in the direction of an arrow R1 in FIG. 1 (hereinafter, also referred to as a “mounting direction”), and is detached by being moved in the direction of an arrow R2 (hereinafter, also referred to as a “detaching direction”), that is, its mounted state is released.

A sheet feeding unit 230 is provided in the body unit 210, and a supply unit 240 is attached to the accommodating unit 220. In a state where the accommodating unit 220 is mounted in the body unit 210, a feed roll 232 of the sheet feeding unit 230 and a retard roll 241 of the supply unit 240 are abutted on each other so as to separate sheets P which are fed from a nudger roll 231 one by one and transport the separated sheets P to the image forming apparatus 100.

(2) Transport Device

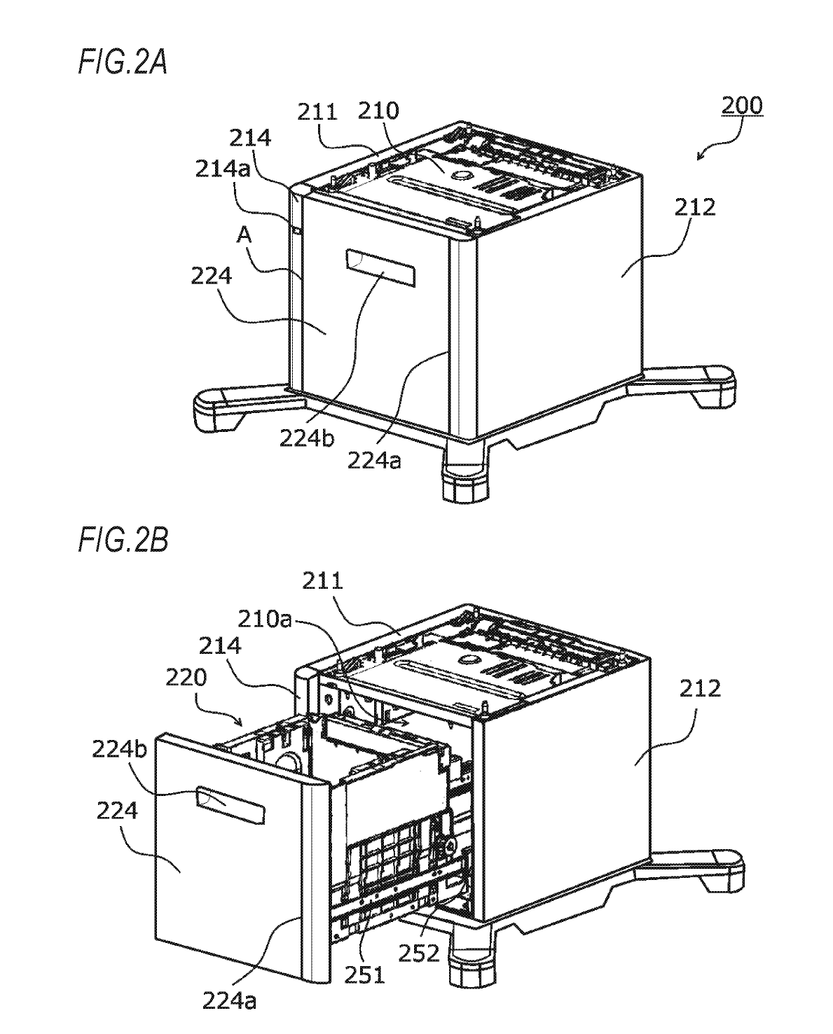

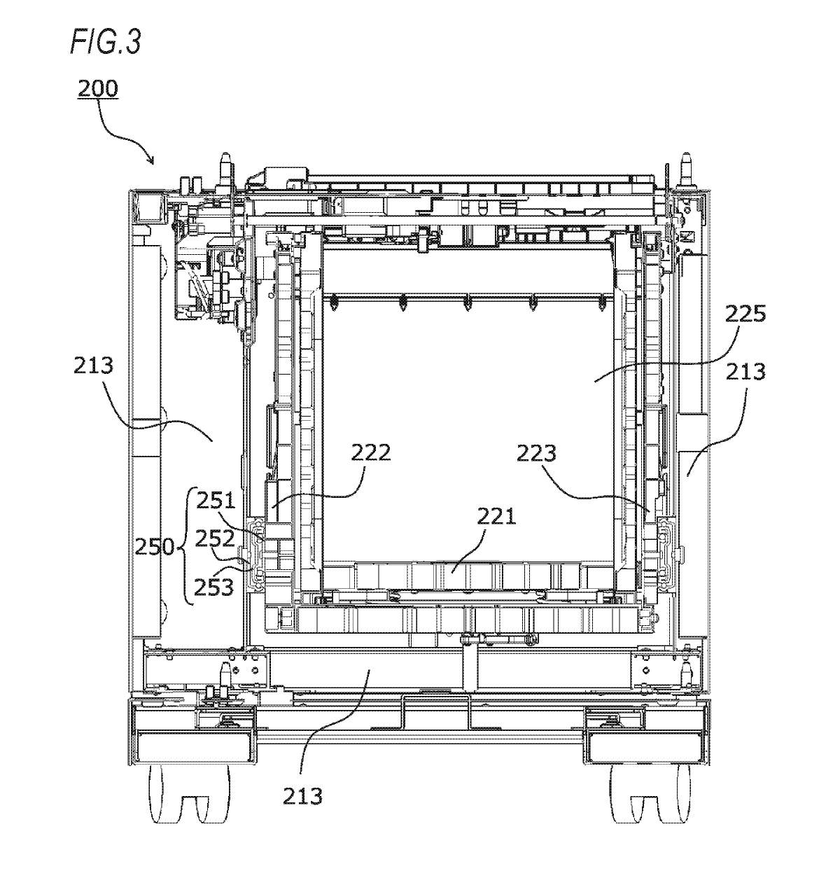

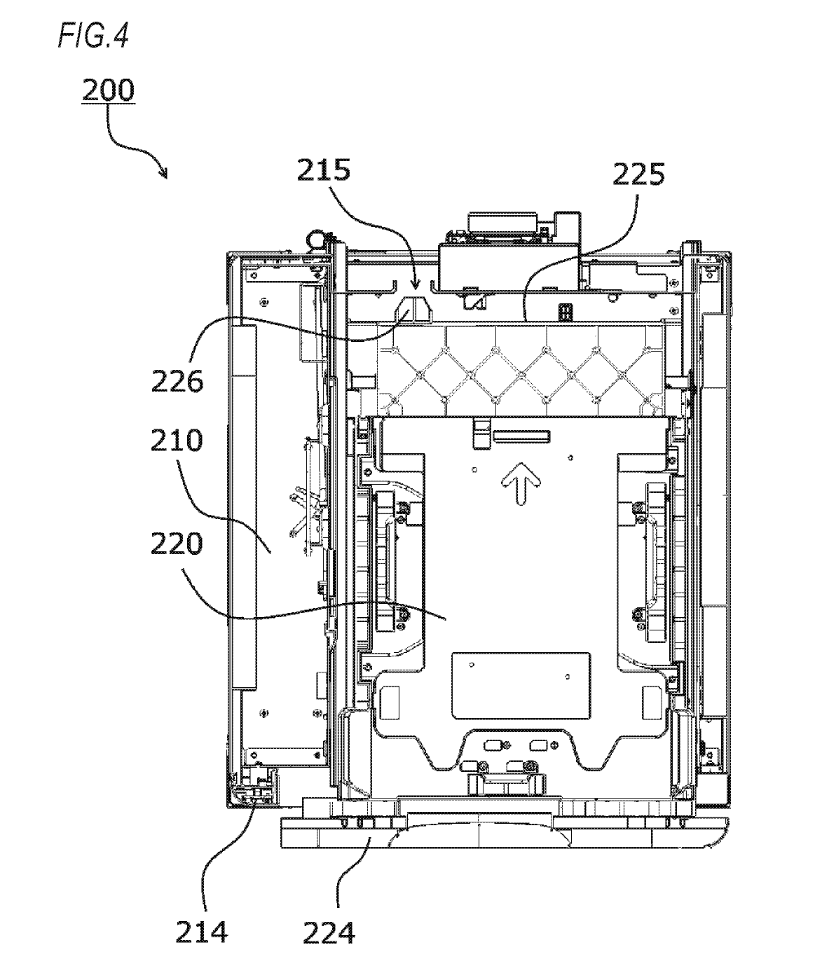

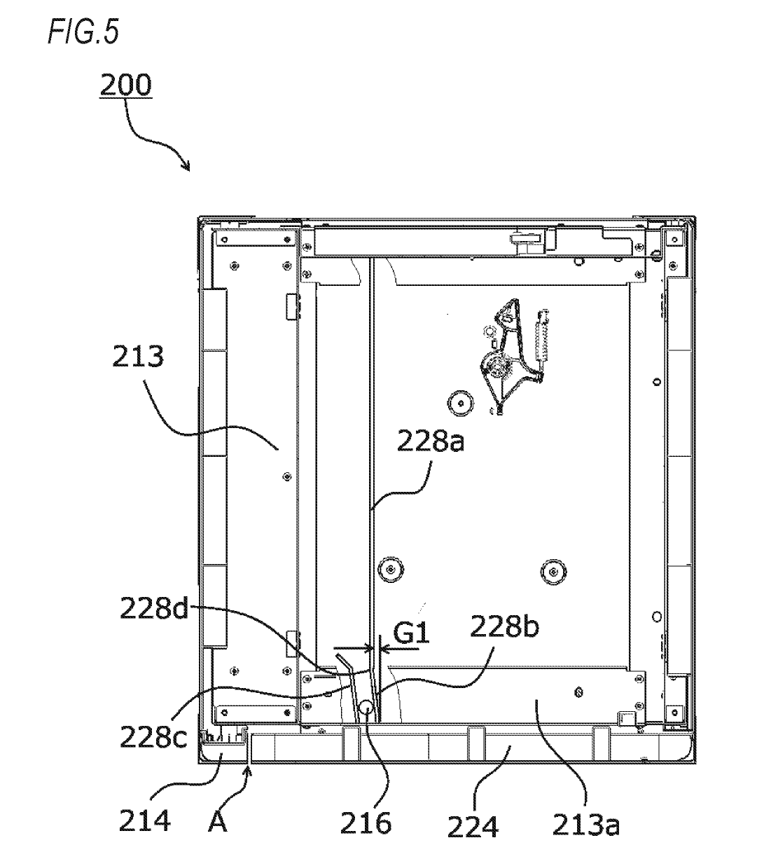

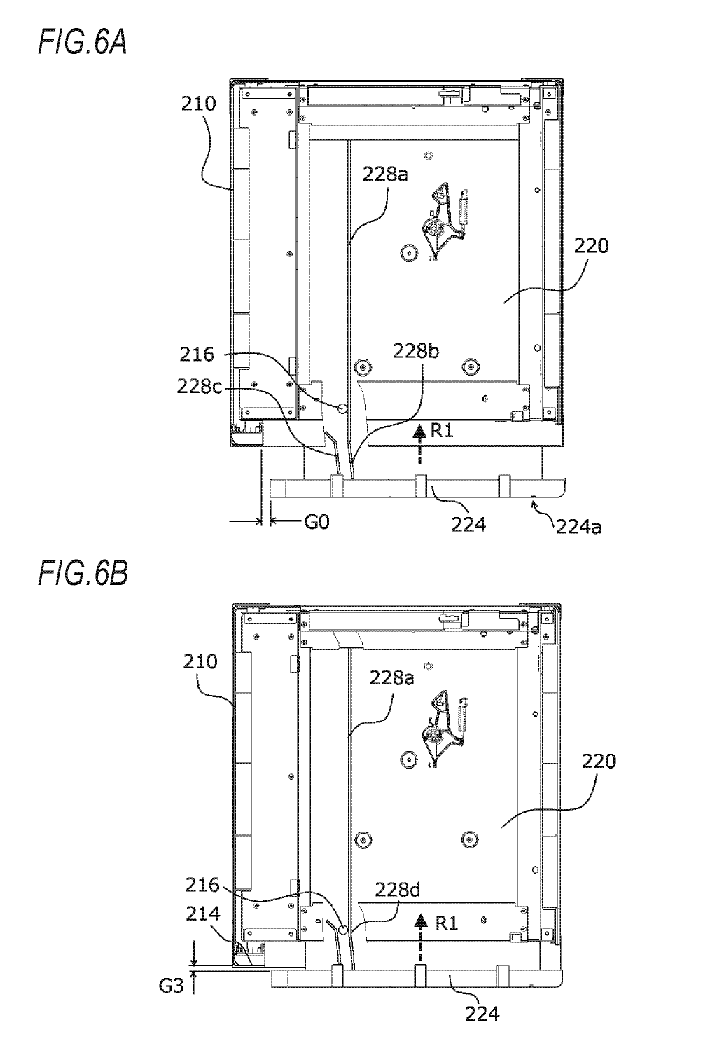

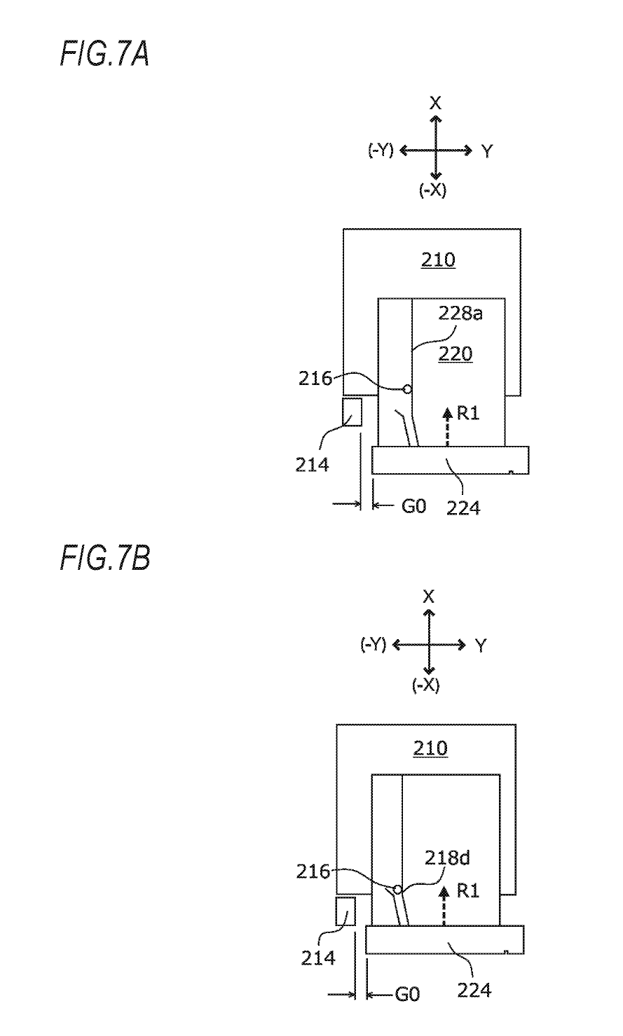

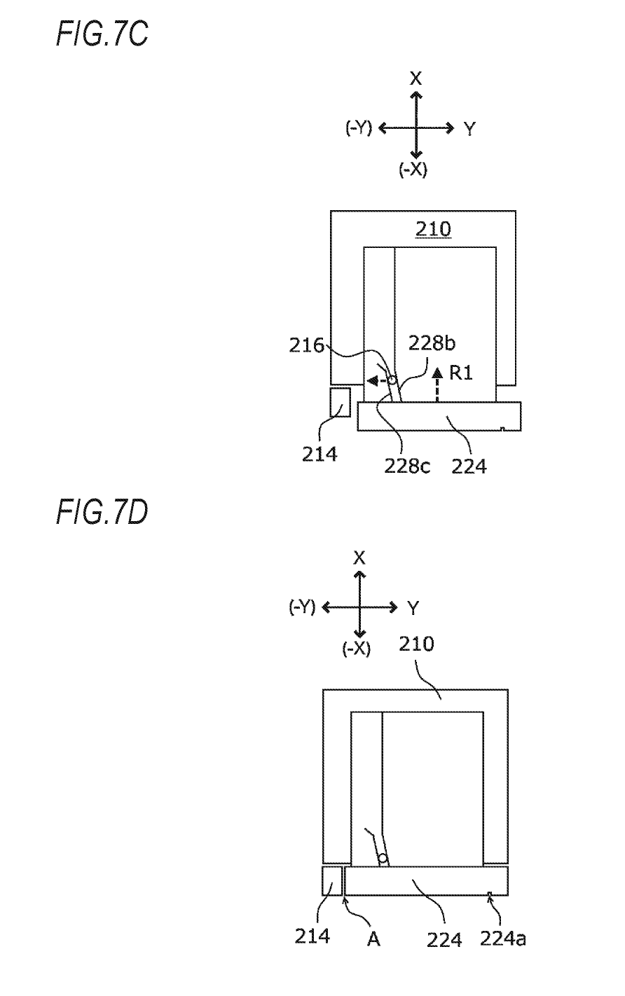

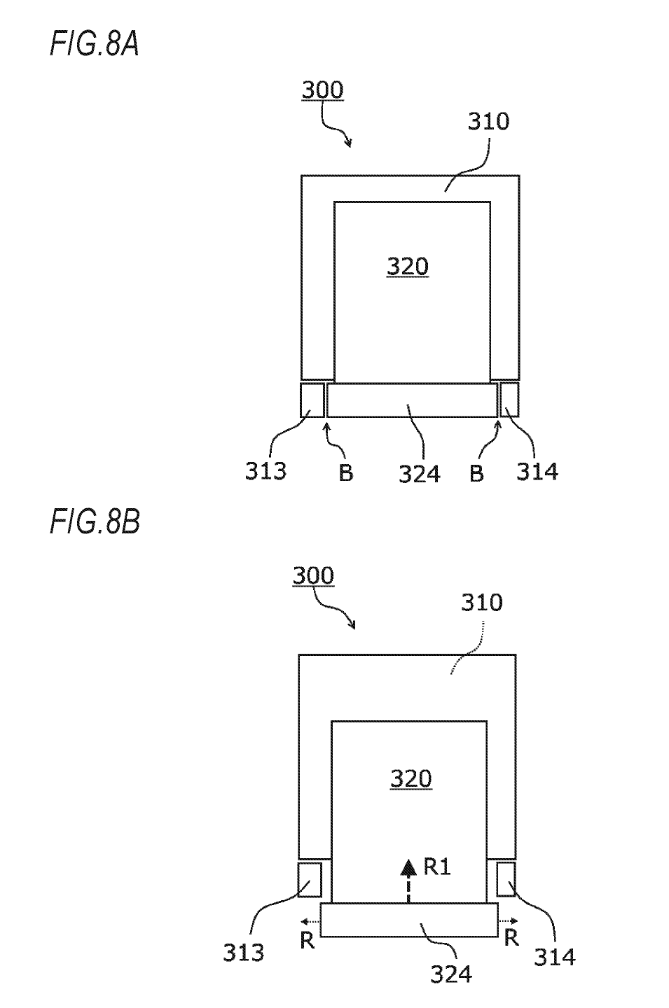

FIG. 2A is a perspective view illustrating the whole of the transport device 200, and FIG. 2B is a perspective view illustrating a state where the accommodating unit is pulled out. FIG. 3 is a vertical sectional view of the transport device 200. FIG. 4 is a plan view of the transport device 200 in a state where the accommodating unit 220 is slightly pulled out. FIG. 5 is a bottom view illustrating a guide mechanism of the transport device 200. FIG. 6A is a bottom view of the transport device 200 in the state where the accommodating unit 220 is slightly pulled out, and FIG. 6B is a bottom view of the transport device 200 in a process of mounting the accommodating unit 220. FIGS. 7A to 7D are bottom schematic diagrams illustrating positioning of the accommodating unit with respect to the body unit. FIGS. 8A and 8B are bottom schematic diagrams illustrating mounting an accommodating unit into a body unit in a transport device of a comparative example.

Hereinafter, descriptions will be made on the configuration of the transport device 200 and the mounting operation of the accommodating unit 220 with reference to the drawings.

(2.1) Overall Configuration

As illustrated in FIGS. 2A and 2B, the transport device 200 includes the body unit 210 and the accommodating unit 220 reciprocally held by the body unit 210.

In the body unit 210, the sheet feeding unit 230 (illustrated in FIG. 1) is provided within a metallic housing 213 (illustrated in FIG. 3) formed with an opening 210a at one surface thereof. The side surfaces of the housing 213 are covered with outer covers 211 and 212 made of a synthetic resin, and one side portion of the opening 210a is covered with a synthetic resin-made front cover 214 as a first cover member.

A display 214a is provided on the front cover 214 to display a state of the transport device 200. The display 214a is provided in the body unit 210 so that a user can visually recognize the state of the transport device 200 even at the time of the mounting/dismounting operation of the accommodating unit 220.

The accommodating unit 220 is a box-shape tray in its entirety which includes a bottom plate 221, side plates 222 and 223, a front cover 224 as a second cover member, and a back plate 225, all of which are made of a synthetic resin material, and the supply unit 240 (illustrated in FIG. 1) is attached to the accommodating unit 220.

A groove portion 224a is formed vertically (in the Z direction) in the side portion of the front cover 224, and configured to be paired with a gap A formed between the front cover 214 of the body unit 210 and the front cover 224 of the accommodating unit 220 so as to present a design line in appearance when the accommodating unit 220 is mounted in the body unit 210.

As illustrated in FIGS. 2B and 3, the accommodating unit 220 is reciprocally supported with respect to the opening 210a of the body unit 210 by a moving mechanism 250.

The moving mechanism 250 is a rail mechanism including first rails 251 attached to the side plates 222 and 223 of the accommodating unit 220, second rails 252 assembled to the body unit 210 to be slidable with respect to the first rails, and intermediate rails 253 disposed to be slidable with respect to the second rails 252. The moving mechanism 250 supports the accommodating unit 220 to be mounted or dismounted with respect to the body unit 210.

The accommodating unit 220 is guided through a guide mechanism 260 to a mounting position in the body unit 210 to be positioned therein.

As illustrated in FIG. 4, a positioning projection 226 is formed on the back plate 225 of the accommodating unit 220 to project toward the body unit 210, and a positioning hole 215 is provided in the body unit 210. The positioning projection 226 and the positioning hole 215 are fitted to each other to constitute a positioning portion when the accommodating unit 220 is mounted in the body unit 210.

As illustrated in FIG. 5, a positioning pin 216 projecting upward (the Z direction) from a bottom surface 213a of the housing 213 is provided in the body unit 210 (FIG. 4 omits illustration of a part of the bottom surface 213a), and a positioning guide 228 is formed on the bottom plate 221 of the accommodating unit 220. When the accommodating unit 220 is mounted in the body unit 210, the positioning pin 216 and the positioning guide 228 are fitted to each other to guide the accommodating unit 220 such that the front cover 224 of the accommodating unit 220 and the opening 210a of the body unit 210 match with each other.

The positioning guide 228 includes a first guide unit 228a extending in the reciprocation direction of the accommodating unit 220, a second guide unit 228b formed to obliquely intersect with the reciprocation direction of the accommodating unit 220 at the front cover 224 side of the accommodating unit 220, and a third guide unit 228c opposite to the second guide unit 228b to form a guide groove toward the positioning pin 216.

The base end of the second guide unit 228b is formed to be deviated from the first guide unit 228a in the direction intersecting with the reciprocation direction of the accommodating unit 220 (see G1 in FIG. 5)

In addition, as illustrated in FIG. 6B, a connection portion 228d between the terminal end of the second guide unit. 228b and the base end of the first guide unit 228a is provided at the position in contact with the positioning pin 216 before the front cover 224 overlaps with the front cover 214 of the body unit 210 in the plan view (see G3 in FIG. 6B) when the accommodating unit 220 is mounted in the body unit 210.

(2.2) Mounting Operation of Accommodating Unit When the transport device 200 is replenished with sheets P as recording mediums, a handle portion 224b (see FIGS. 2A and 2B) of the front cover 224 is operated to move the accommodating unit 220 from the body unit 210 in the direction of the arrow R2 (see FIG. 1) such that a sheet bundle is stacked on the sheet stacking plate BP in a state where the sheet stacking plate BP is exposed.

After the sheets P are stacked on the sheet stacking plate BP, the handle portion 224b of the front cover 224 is operated so that the accommodating unit 220 is moved in the direction of the arrow R1 to be mounted in the body unit 210.

The accommodating unit 220 is a box-shape tray in its entirety which includes the bottom plate 221, the side plates 222 and 223, the front cover 224, and the back plate 225 all of which are made of a synthetic resin material, and s lighter as a whole as compared to one made of a metal. Meanwhile, according to the temperature condition of the use environment where the transport device 200 is provided, a part or the whole of the accommodating unit 220 may be more easily expanded or shrunk as compared to one made of a metal.

As illustrated in FIGS. 8A and 8B, in a transport device 300 of a comparative example, a body unit 310 includes front covers 313 and 314 that cover the opposite side portions of an opening, and an accommodating unit 320 includes a synthetic resin-made front cover 324 that covers an opening 310a while forming a gap B as a design line between the front cover 324 and each of the front covers 313 and 314 of the body unit 310 in the state where the accommodating unit 320 is mounted in the body unit 310.

In the transport device 300 configured as described above, when the synthetic resin-made accommodating unit 320 is thermally expanded, the front cover 324 is also thermally expanded (see each arrow R FIGS. 8A and 8B) so that the gap B between the front cover 324 and each of the front covers 313 and 314 of the body unit 310 may become small thereby causing interference therebetween when the accommodating unit 320 is mounted in the body unit 310. When the gap B is made large in consideration of the thermal expansion, the favorable appearance of the design line may be deteriorated.

In the transport device 200 according to the present exemplary embodiment, one side portion of the opening 210a of the body unit 210 is covered by the synthetic resin-made front cover 214 as a first cover member.

The accommodating unit 220 includes the front cover 224 of which one side portion matches with the front cover 214 of the body unit 210 and the other side portion covers the other side portion of the body unit 210, in the state where the accommodating unit 220 is mounted in the body unit 210. Hence, in the state where the accommodating unit 220 is mounted in the body unit 210, the accommodating unit 220 is brought into a state where one side end of the accommodating unit 220 matches with the front cover 214 of the body unit 210, and the other side end thereof covers the other side portion of the body unit 210.

The positioning pin 216 projecting upward (the Z direction) from the bottom surface 213a of the housing 213 is provided in the body unit 210, and the positioning guide 228 is formed on the bottom plate 221 of the accommodating unit 220.

When the accommodating unit 220 is mounted in the body unit 210 (see the arrow R1), the accommodating unit 220 is mounted therein in a state where the first guide unit 228a is in contact with the positioning pin 216 such that the accommodating unit 220 is disposed to the right side (the Y direction), as first schematically illustrated in FIG. 7A, while maintaining a gap G0 between the front cover 214 of the body unit 210 and the end of the front cover 224 of the accommodating unit 220.

Then, as illustrated in FIG. 7B, the accommodating unit 220 enters into the body unit 210. After the connection portion 228d between the terminal end of the second guide unit 228b and the base end of the first guide unit 228a is in contact with the positioning pin 216, the accommodating unit 220 is disposed in a position where the front cover 224 overlaps with the front cover 214 of the body unit 210 in the plan view.

Subsequently, as illustrated in FIG. 7C, when the positioning pin 216 is brought into the state of being in contact with the second guide unit 228b and the third guide unit 228c, the accommodating unit 220 is mounted while being moved to the left side (the −Y direction), and positioned in a state of forming the gap A between the front cover 214 of the body unit 210 and the end of the front cover 224 of the accommodating unit 220 (see FIG. 7D).

Hence, even when the synthetic resin-made accommodating unit 220 is thermally expanded, the end of the front cover 224 and the front cover 214 of the body unit 210 do not interfere with each other, and it is possible to form a design line in appearance in the gap A formed between the front cover 214 of the body unit 210 and the front cover 224 of the accommodating unit 220 and the groove portion 224a provided in the side portion of the front cover 224.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transport device comprising:
a body unit including a first cover member attached thereto to cover a first side portion of an opening formed at one surface of the body unit;
an accommodating unit including a second cover member attached thereto to cover the opening, the accommodating unit being configured to accommodate a recording medium, the accommodating unit being reciprocally mounted with respect to the opening of the body unit; and
a guide member provided on a bottom surface of the accommodating unit, the guide member being configured to guide the accommodating unit so that when the accommodating unit is mounted in the body unit, while being fitted to a positioning pin provided in the body unit, the guide member is positioned so that the second cover member has a gap with the first cover member at a position where the accommodating unit is mounted in the body unit,
wherein the second cover member is configured to cover a second side portion of the opening, and
wherein the second side portion of the opening is opposite to the first side portion of the opening.

2. The transport device according to claim 1, wherein the guide member includes
a first guide unit configured to guide the accommodating unit in a reciprocation direction with respect to the body unit when the accommodating unit is mounted in the body unit, and
a second guide unit configured to guide the accommodating unit in a direction obliquely intersecting with the reciprocation direction when the accommodating unit is mounted in the body unit, and
the guide member is configured to guide the accommodating unit to move the accommodating unit to the direction intersecting with the reciprocation direction.

3. The transport device according to claim 1, wherein the guide member is fitted to the positioning pin before the first cover member and the second cover member overlap with each other in a reciprocation direction of the accommodating unit when viewed from a top side.

4. The transport device according to claim 2, wherein the guide member is fitted to the positioning pin before the first cover member and the second cover member overlap with each other in the reciprocation direction of the accommodating unit when viewed from a top side.

5. The transport device according to claim 1, wherein the accommodating unit is made of a synthetic resin.

6. The transport device according to claim 2, wherein the accommodating unit is made of a synthetic resin.

7. The transport device according to claim 3, wherein the accommodating unit is made of a synthetic resin.

8. The transport device according to claim 4, wherein the accommodating unit is made of a synthetic resin.

9. The transport device according to claim 1, wherein the second cover member is detached from the second side portion.
